(19) United States
(12) Patent Application Publication
(10) Pub. No.: US 2005/0161081 A1
(43) Pub. Date: Jul. 28, 2005

(54) System and method for treating a fluid in a pipe

(75) Inventors: Ali Mese, Houston, TX (US); Mohamed Y. Soliman, Cypress, TX (US); Clark Robison, Tomball, TX (US)

Correspondence Address: John W. Wustenberg;HALLIBURTON ENERGY SERVICES, P.O. Box 1431, 2600 South Second Street, Duncan, OK, 73536-0440, US

(73) Assignee: Halliburton Energy Services

(21) Appl. No.: 10/762,970

(22) Filed: Jan. 22, 2004

(51) Int. Cl. F15C 1/04

(52) U.S. Cl. 137/13; 137/828

(57) ABSTRACT

A system and method for treating a fluid flowing in a pipe according to which an element is provided in the pipe that vibrates to produce acoustic energy. The strength and frequency of the acoustic energy are such that the viscosity of the fluid is reduced.

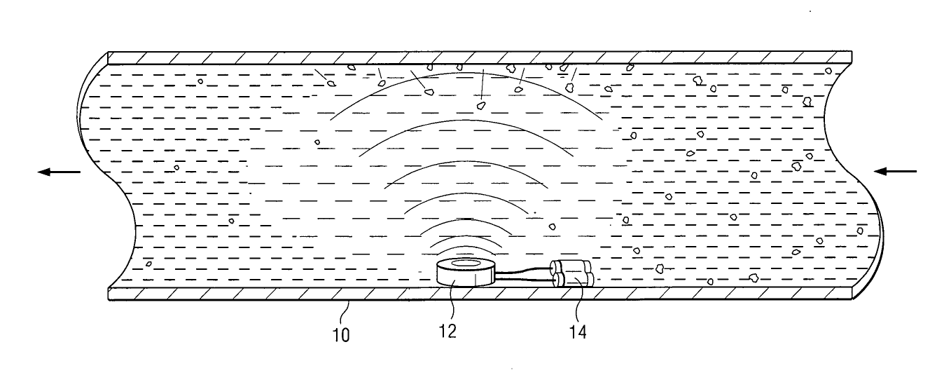

### BACKGROUND

This invention relates to a system and method for treating a fluid flowing in a pipe and, more particularly, to increase the viscosity of the fluid.

When certain fluids, such as crude oil, are introduced into a pipe at an elevated temperature, the temperature of the fluid will decrease as it flows through the pipe which causes a corresponding increase in the viscosity of the fluid. Also, layers of the fluid as well as various types of materials, such as wax, waxy materials, hydrates, and/or asphaltic components (these materials, as well as other materials that may be present in the fluid, are hereinafter collectively referred to as “materials”), that are present in the fluid may deposit on the inner wall of the pipe.

The above increases in the viscosity of the fluid, the presence of materials in the fluid, and the build up of the fluid and the materials on the pipe wall, impede the flow of the fluid through the pipe. Therefore, the amount of pressure, and therefore energy, required to pump the fluid through the pipe is increased.

The present invention is an improved, non-invasive, technique for reducing the viscosity of the fluid as it flows through the pipe and for removing materials from the wall of the pipe.

### BRIEF DESCRIPTION OF THE DRAWINGS

The drawing is a sectional view of a pipe depicting an embodiment of the invention.

### DETAILED DESCRIPTION

Referring to the drawing, the reference 10 refers, in general, to a pipe which may be part of a pipeline or piping system for the purpose of transporting a fluid, such as crude oil or other hydrocarbons, from a source to a destination. It is understood that materials (defined above) may be contained in the fluid and some of the materials may accumulate on the inner wall of the pipe 10.

According to an embodiment of the present invention, an electromechanical transducer 12 is placed in the interior of the pipe 10 and affixed to the inner wall of the pipe 10 in any conventional manner. An example of the transducer 12 is disclosed in U.S. Pat. No. 6,619,394, the disclosure of which is incorporated herein by reference in its entirety.

The transducer 12 is connected to an electrical energy source 14 which, for the purpose of example, is also shown in the interior of the pipe 10. The electrical energy source 14 can be in the form of a battery pack, or other electrical power source.

The transducer 12 includes an active element, preferably in the form of a piezoelectric ceramic, that is adapted to vibrate in response to an electrical input to produce oscillatory waves at an ultrasonic frequency. This acoustic energy has two mechanisms, one of which is an acoustic cavitation mechanism that causes an increase of the local temperature of the fluid which decreases the viscosity of the fluid and therefore decreases the amount of materials contained in the fluid. The other mechanism is an acoustic streaming mechanism which disintegrates any materials, and/or layers of the fluid on the wall of the pipe 10. The acoustic cavitation mechanism and the acoustic streaming mechanism are well disclosed in the article entitled “Acoustic streaming and temperature elevation in focused Gaussian beams” written by Hai-Ying Huang, Tomoo Kamakura, and Yoshiro Kumamoto and published in the Journal of Acoustic Society Japan, (E) 18,5 (1997), the disclosure of which is incorporated herein by reference in its entirety.

In the present case, the strength and frequency of the acoustic energy from the transducer 12 is adjusted depending on the type, flow rate, and temperature of the fluid in the pipe 10, as well as the build up of the fluid and materials on the wall of the pipe 10, so that the acoustic energy (1) reduces the viscosity of the fluid, (2) removes any layers of the fluid on the wall of the pipe 10, (3) removes any materials contained in the fluid, and (4) removes any of the materials accumulating on the wall of the pipe 10.

In achieving the above, the particles of material contained in the fluid and accumulating on the wall of the pipe 10, are disintegrated into very small particles. The latter particles are either dissolved into the fluid or easily carried by the fluid as it flows in the pipe 10 to the destination.

It is understood that the pipe 10 may be utilized to transfer fluid from a well to the surface including applications involving a fluid at an elevated temperature that flows upwardly as it cools down. This is especially true for offshore wells in oil recovery operations when the temperature of the oil quickly drops when it moves into a riser. The pipe 10 may also be utilized to transfer fluid containing hydrocarbons between surface facilities. The above embodiment also lends itself to relative long pipelines and/or pipelines in a relatively cold area.

Several variations of the above may be made within the scope of the invention. For example, although only one transducer 12 is shown and discussed above, it is understood that additional transducers can be placed in the pipe 10 at spaced intervals. Also, the transducer 12 is not limited to the one disclosed in the above patent, but can take other forms. Further, the electrical source 14 can be located externally of the pipe 10 and connected to the transducer 12 by suitable electrical conductors. Still further, the transducer 12 can include an active element, other than a piezoelectric ceramic, that is adapted to vibrate in response to an electrical input to produce the acoustic energy discussed above. Moreover, the present invention is not limited to the fluids discussed above, nor to the removal of any particular materials from any particular fluid, but is equally applicable to other fluids and/or materials.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method for treating a fluid flowing in a pipe, the method comprising:
vibrating an element in the pipe to produce acoustic energy; and
adjusting the strength and frequency of the acoustic energy to reduce the viscosity of the fluid.

2. The method of claim 1 further comprising adjusting the strength and frequency of the acoustic energy to remove any layers of the fluid on the wall of the pipe.

3. The method of claim 1 further comprising adjusting the strength and frequency of the acoustic energy to disintegrate any materials contained in the fluid.

4. The method of claim 1 further comprising adjusting the strength and frequency of the acoustic energy to remove any materials contained in the fluid that accumulate on the wall of the pipe.

5. The method of claim 1 further comprising adjusting the strength and frequency of the acoustic energy to remove any layers of the fluid on the wall of the pipe, disintegrate any materials contained in the fluid, and remove any materials contained in the fluid that accumulate on the wall of the pipe.

6. The method of claim 1 wherein the acoustic energy is in the form of ultrasonic waves that are propagated through the fluid.

7. The method of claim 6 wherein the waves oscillate at an ultrasonic frequency to produce an oscillatory force that is applied to the fluid and any materials contained in the fluid.

8. The method of claim 1 wherein the acoustic energy includes an acoustic cavitation mechanism that causes an increase of the local temperature of the fluid which decreases the viscosity of the fluid and therefore decreases the amount of any materials contained in the fluid.

9. The method of claim 8 wherein the acoustic energy also includes an acoustic streaming mechanism which disintegrates any materials on the wall of the pipe.

10. The method of claim 1 wherein the vibration of the element produces heat and causes mechanical shear and cavitations in any materials contained in the fluid due to molecular bonds and attractions.

11. The method of claim 6 wherein the fluid is a hydrocarbon.

12. The method of claim 11 wherein the hydrocarbon is a crude oil.

13. A system for treating a fluid flowing in a pipe, the system comprising an element disposed in the pipe that vibrates to produce acoustic energy of a strength and frequency to reduce the viscosity of the fluid.

14. The system of claim 13 further comprising an electrical source electrically connected to the element to apply an electrical input to the element to vibrate the element.

15. The system of claim 14 wherein the electrical source is disposed in the pipe.

16. The system of claim 14 wherein the electrical source is a battery pack.

17. The system of claim 13 wherein the element is a piezoelectric ceramic.

18. The system of claim 13 wherein the strength and frequency of the acoustic energy is such that it removes any layers of the fluid on the wall of the pipe.

19. The system of claim 13 wherein the strength and frequency of the acoustic energy is such that it disintegrates any materials contained in the fluid.

20. The system of claim 13 wherein the strength and frequency of the acoustic energy is such that it removes any materials contained in the fluid that accumulate on the wall of the pipe.

21. The system of claim 13 wherein the strength and frequency of the acoustic energy is such that it removes any layers of the fluid on the wall of the pipe, disintegrates any materials contained in the fluid, and removes any materials contained in the fluid that accumulate on the wall of the pipe.

22. The system of claim 13 wherein the acoustic energy is in the form of ultrasonic waves that are propagated through the fluid and any materials contained in the fluid.

23. The system of claim 22 wherein the waves oscillate at an ultrasonic frequency to produce an oscillatory force that is applied to the fluid and the materials.

24. The system of claim 13 wherein the acoustic energy includes an acoustic cavitation mechanism that causes an increase of the local temperature of the fluid which decreases the viscosity of the fluid and therefore decreases the amount of any materials contained in the fluid.

25. The system of claim 24 wherein the acoustic energy also includes an acoustic streaming mechanism which disintegrates any materials on the wall of the pipe.

26. The system of claim 13 wherein the vibration of the element produces heat and causes mechanical shear and cavitations in any materials contained in the fluid due to molecular bonds and attractions.
